(19) United States
(12) Patent Application Publication
(10) Pub. No.: US 2006/0280529 A1
(43) Pub. Date: Dec. 14, 2006

(54) Image forming method and apparatus for effectively conveying developer

(76) Inventors: Shuuichi Nakagawa, Osaka (JP); Ryuji Inoue, Hyougo (JP); Yoshiko Ogawa, Osaka (JP); Shin Murayama, Hyougo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/449,684

(22) Filed: Jun. 9, 2006

(30) Foreign Application Priority Data
Jun. 10, 2005 (JP) JP2005-170782

(51) Int. Cl. G03G 15/08

(52) U.S. Cl. 399/281; 399/284

(57) ABSTRACT

A developing device includes a developer bearing member configured to bear a developer on a surface thereof, a developer supplying member configured to supply the developer to the developer bearing member, a regulating member configured to regulate the developer supplied on the surface of the developer bearing member to form into a thin layer, and being located at a position lower than a nip of the developer bearing member and the developer supplying member, and a partition wall configured to divide the developing device into two chambers, and arranged with at least one developer path having a bottom portion thereof located lower than a contact point of the developer bearing member and the regulating member.

### CROSS REFERENCE TO RELATED APPLICATIONS

The present application claims priority to Japanese patent application no. 2005-170782, filed in the Japan Patent Office on Jun. 10, 2005, the disclosure of which is incorporated by reference herein in its entirety.

### BACKGROUND

1. Field of Invention

Exemplary aspects of the present invention relate to an image forming method and apparatus for effectively conveying developer. More particularly, exemplary aspects of the present invention relate to a developing device using a method of manufacturing the developing device for effectively conveying developer, a development cartridge integrally mounted with the developing device, and an electrophotographic image forming apparatus including the developing device or the development cartridge with the developing device or mechanism that can provide images in high quality.

2. Discussion of the Related Art

A related art electrophotographic method is used in an image forming apparatus, for example, a copier, laser printer, facsimile machine and the like. Various image forming processes for background electrophotographic methods have been proposed in a plurality of categories, for example, of forming an electrostatic latent image, developing, fixing and the like.

Related art electrographic developing methods include techniques using a one-component developer including magnetic toner or nonmagnetic toner, and a two-component developer including magnetic toner or nonmagnetic toner and a carrier. The developing method using a one-component nonmagnetic developer has advantages in that toner does not include magnetic materials, such as ferrite, magnetite and so forth, that a carrier is not necessary, and that a developer bearing member, such as a developing roller, does not include magnetic materials. These advantages can promote availability of image forming operation using the electrophotographic methods, in view of applicability to full color printers, maintenance ability, manufacturing and running cost, and post-processing of various materials.

The one-component nonmagnetic developer is generally prepared by adding a fluidity imparting agent, such as silica, alumina, titanium oxide and the like, to toner containing binding resin, such as styrene-acrylic copolymer, styrene-butadiene copolymer and the like, a colorant, such as carbon black and other various pigments, and additives, such as charge control agents, as major components. The one-component nonmagnetic developer is contained in a developing device. When developing an electrostatic latent image, the nonmagnetic developer contained in the developing device is conveyed toward a photoconductive element on which the electrostatic latent image is formed. The nonmagnetic developer is applied with a developing bias, and is conveyed by a developer bearing member to the photoconductive element to develop the electrostatic latent image formed thereon to a visible toner image.

Prior to developing the electrostatic latent image formed on the photoconductive element, charge by friction is performed to the nonmagnetic developer to apply with an electric charge having a polarity opposite to the electrostatic latent image. The charge by friction is substantially performed to apply an electric charge to a developer. As a method of frictionally applying an electric charge to a developer, a regulating member that regulates the thickness of a layer of developer is disposed in a developing device. The regulating member is held in contact with a developer charging member disposed in the developing device.

In a background developing device, a regulating blade, serving as a layer regulating member for regulating the thickness of a layer of developer, is disposed at a position upper than a developer bearing member so that the regulating blade can apply a charge by friction to the developer and can regulate an amount of developer. The background developing device includes a lower partition wall. The lower partition wall is disposed between a holding chamber and a development chamber in the developing device. By providing a groove at both end parts of a lower partition wall, flowability of toner in the developing device can be promoted, especially at both end parts of the lower partition wall. Thereby, weakly aggregated toner or blocking toner generated in the vicinity of the both end parts of the low partition wall in the developing device can be returned to the holding chamber so that deterioration in image caused by the weakly aggregated toner and/or blocking toner can be prevented.

In another related art developing device, a one-component developer and a developer bearing member including a magnetic material are used to perform a charge by friction and to supply the one-component developer to the developer bearing member. The background developing device includes a layer regulating member. One end of the layer regulating member is fixed at a position upper than the developer bearing member, and the other end of the layer regulating member is held in contact with an upper portion of the developer bearing member. Thus, the layer regulating member regulates the thickness of a layer of developer. In this background developing device, the layer thickness is regulated at the upper portion of the developer bearing member. Therefore, the developer removed by the layer regulating member from the developer bearing member is moved downwardly, and thereby the developer does not remain in the vicinity of the layer regulating member.

Further in another related art developing device, a roller is used as a layer regulating member to regulate the thickness of a layer of developer while a layer regulating member shaped like a blade is not used.

In the above-described developing devices, each layer regulating member is disposed at a position upper than a position in which a developer is stored in a developing chamber. The layer regulating member, however, is not used to exert a pressure to regulate the thickness of a layer of developer when the developer supplied from a developer supplying member and the developer removed by the layer regulating member gather in the vicinity of the layer regulating member.

In recent years, office space has been saved and office supplies are generalized and diversified. Under the above-described circumstances, there are increasing demands for a downsized and low-cost image forming apparatus using an electrophotographic method with a smaller and less expensive developing device therein. To respond to the above-described demands, a layer regulating member can be made in a form of a blade and be disposed in a developing device, at a lower position as possible.

However, a problem may occur when a layer regulating member is arranged at a position lower than a developer supplying member, especially lower than a point of a developer bearing member and a developer supplying member. That is, when developer is regulated by a layer regulating member, the developer removed from the developer bearing member by the layer regulating member may gather and remain in the vicinity of the layer regulating member. There, the developer removed from the developer bearing member gathering in the vicinity of the layer regulating member and the developer supplied to the layer regulating member can easily receive a pressure exerted by the layer regulating member. Under the above-described condition, the developer can weakly be aggregated or block a flow of the developer in the vicinity of the layer regulating member in the developing device. When passing the layer regulating member, the aggregated or blocking developer may choke a path between the layer regulating member and the developer bearing member. As a result, the above-described status can cause image defects, such as noise streaks and/or unevenness on image and insufficient toner density.

### SUMMARY

Exemplary aspects of the present invention have been made in view of the above-described circumstances.

Exemplary aspects of the present invention provide a developing device that can efficiently convey developer.

Exemplary aspects of the present invention provide a cartridge that can include the above described developing device.

Exemplary aspects of the present invention provide an image forming apparatus that can include the above-described developing device therein or the above-described cartridge including the above-described developing device.

Exemplary aspects of the present invention provide a method of manufacturing the above-described developing device that can be included in the above-described image forming apparatus.

In one exemplary embodiment, a novel developing device includes a developer bearing member configured to bear a developer on a surface thereof, a developer supplying member configured to supply the developer to the developer bearing member, a regulating member configured to regulate the developer supplied on the surface of the developer bearing member to form into a thin layer and being located at a position lower than a nip of the developer bearing member and the developer supplying member, and a partition wall configured to divide the developing device into two chambers and arranged with at least one developer path having a bottom portion thereof located lower than the contact point of the developer bearing member and the regulating member.

The regulating member may have one end in a longitudinal direction thereof being fixedly disposed on a bottom plate of one of the two chambers.

The bottom portion of the at least one developer path may be formed outside of a width direction of an image forming area of the developing device.

The regulating member may be configured to contact the developer bearing member and to have a free end extending in an upward direction over the contact point with the developer bearing member.

The at least one developer path in the image forming area may be configured to be located upper than the free end.

The above-described developing device may be integrally mounted in a cartridge detachable with respect to an image forming apparatus.

Further, in one exemplary embodiment, a novel cartridge includes a housing and a developing device configured to develop an image. The developing device may include a developer bearing member configured to bear a developer on a surface thereof, a developer supplying member configured to supply the developer to the developer bearing member, a regulating member configured to regulate the developer supplied on the surface of the developer bearing member to form into a thin layer and being located at a position lower than a nip of the developer bearing member and the developer supplying member, and a partition wall configured to divide the developing device into two chambers and arranged with at least one developer path having a bottom portion thereof located lower than the contact point of the developer bearing member and the regulating member.

Further, in one exemplary embodiment, a novel image forming apparatus includes an image bearing member configured to bear an image on a surface thereof, a fixing device configured to fix the developer transferred from the image bearing member onto a recording medium, and a developing device configured to develop the image formed on the surface of the image bearing member. The developing device may include a developer bearing member configured to bear a developer on a surface thereof, a developer supplying member configured to supply the developer to the developer bearing member, a regulating member configured to regulate the developer supplied on the surface of the developer bearing member to form into a thin layer and being located at a position lower than a nip of the developer bearing member and the developer supplying member, and a partition wall configured to divide the developing device into two chambers and arranged with at least one developer path having a bottom portion thereof located lower than the contact point of the developer bearing member and the regulating member.

Further, in one exemplary embodiment, a method of manufacturing a developing device for conveying developer therein includes the providing a developer bearing member and a regulating member in the developing device so that the regulating member is held in contact with the developer bearing member at a contact point, and arranging a partition wall with at least one developer path having a bottom portion thereof located lower than the contact point of the developer bearing member and the layer regulating member.

The method may further include arranging the regulating member to have a free end extending in an upward direction over the contact point with the developer bearing member, and locating the at least one developer path in the image forming area to be upper than the free end.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic structure of an image forming apparatus including a developing device integrally mounted in a development cartridge, according to one exemplary embodiment of the present invention;

FIG. 2 is an enlarged view of the developing device of FIG. 1 according to the exemplary embodiment of the present invention;

FIG. 3 is a cross sectional view, along the cross section line B-B in FIG. 2, of the developing device of FIG. 2 according to the exemplary embodiment of the present invention;

FIG. 4 is a cross sectional view, along the cross section line C-C in FIG. 1, of the image forming apparatus of FIG. 1 according to the exemplary embodiment of the present invention;

FIGS. 5(a) and 5(b) are cross sectional views showing a relationship of exemplary developer paths and a contact point between a developer bearing member and a layer thickness regulating member according to a first example of the exemplary embodiment of the present invention;

FIGS. 6(a) and 6(b) are cross sectional views showing a relationship of different exemplary developer paths and the contact point between the developer bearing member and the layer thickness regulating member according to a second example of the exemplary embodiment of the present invention;

FIGS. 7(a) and 7(b) are cross sectional views showing a relationship of different exemplary developer paths and the contact point between the developer bearing member and the layer thickness regulating member according to a third example of the exemplary embodiment of the present invention;

FIGS. 8(a) and 8(b) are cross sectional views showing a relationship of different exemplary developer paths and the contact point between the developer bearing member and the layer thickness regulating member according to a fourth example of the exemplary embodiment of the present invention;

FIG. 9 is a schematic structure of an image forming apparatus including a developing device according to an alternative exemplary embodiment of the present invention;

FIGS. 10(a) and 10(b) are cross sectional views showing a relationship of exemplary developer paths and a contact point between a developer bearing member and a layer thickness regulating member of the developing device according to a first comparative example of the alternative exemplary embodiment of the present invention;

FIGS. 11(a) and 11(b) are cross sectional views showing a relationship of different exemplary developer paths and the contact point between the developer bearing member and the layer thickness regulating member of the developing device according to a second comparative example of the alternative exemplary embodiment of the present invention; and

FIGS. 12(a) and 12(b) are cross sectional views showing a relationship of different exemplary developer paths and the contact point between the developer bearing member and the layer thickness regulating member of the developing device according to a third comparative example of the alternative exemplary embodiment of the present invention.

### DETAILED DESCRIPTION OF THE EXEMPLARY EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, exemplary embodiments of the present invention are described.

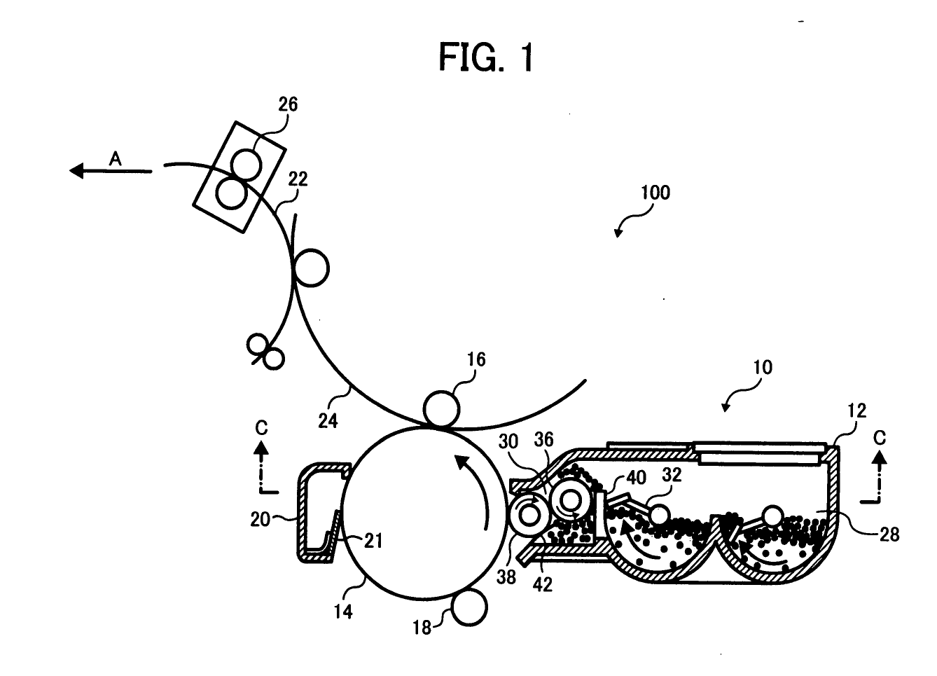

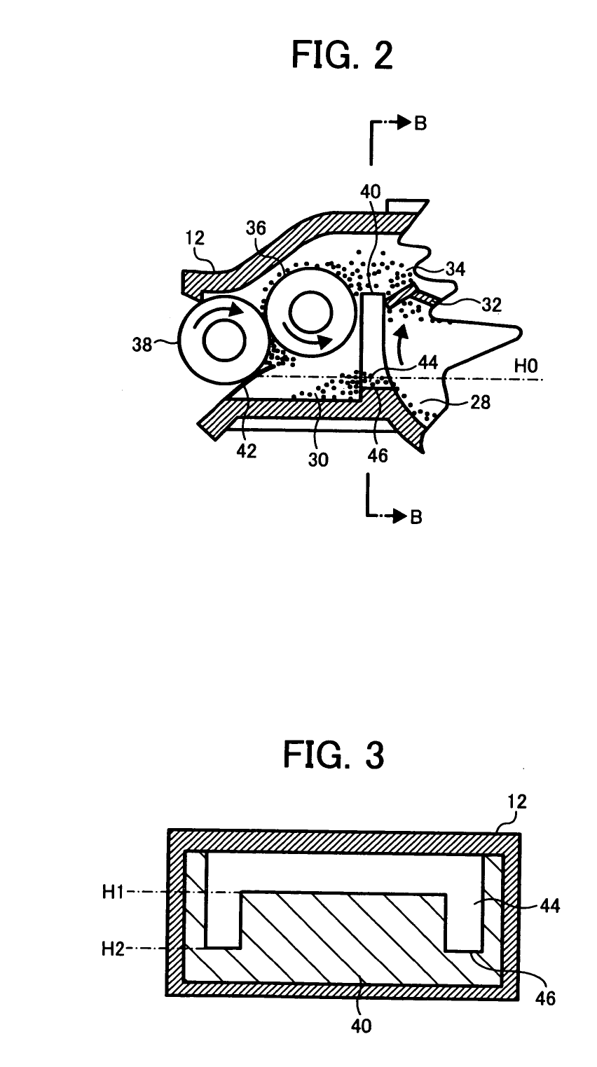

Referring to FIGS. 1 and 2, a schematic structure of an image forming apparatus 100 according to one exemplary embodiment of the present invention is described.

FIG. 1 shows a developing device 12 integrally mounted in a development cartridge 10 according to the exemplary embodiment of the present invention.

In FIG. 1, the development cartridge 10 can be detachably attached to an image forming apparatus, for example, an electrophotographic copier producing a single color image, facsimile machine, laser printer, full color laser printer and the like. The development cartridge 10 includes the developing device 12 according to an exemplary embodiment of the present invention.

The image forming apparatus 100 shown in FIG. 1 also includes an image bearing member 14, a primary transfer member 16, a secondary transfer member (not shown), a charging member 18, an optical writing device (not shown), a developer collecting device 20, an intermediate transfer member 24, and a fixing device 26. The developing device 12 supplies a developer 34 (see FIG. 2) to the electrostatic latent image formed on the surface of the image bearing member 14.

The image bearing member 14 is disposed in the vicinity of one side of the developing device 12. In this exemplary embodiment, the image bearing member 14 is a drum-shaped photoconductive element. However, a belt-shaped photoconductive element is also applicable to the present invention, which will be described later.

The charging member 18, in a form of a charging roller in the exemplary embodiment, is held in contact with the image bearing member 14. The charging member 18 is used to uniformly charge a surface of the image bearing member 14.

The intermediate transfer member 24 forming an endless belt receives an image from the photoconductive element 14.

The transfer member 16 is disposed opposite to the image bearing member 14, sandwiching the intermediate transfer member 24.

The primary transfer member 16 transfers an image from the image bearing member 14 to the intermediate transfer member 24 before the developer 34 on the image is fixed onto a recording medium 22 by the fixing device 26.

The developer cleaning device 20 includes a cleaning blade 21, and is disposed to be held in contact with the image bearing member 14. The developer cleaning device 20 removes developer remaining on the image bearing member 14.

Operations of image forming using the development cartridge 10 of the image forming apparatus 100 shown in FIG. 1 are described below.

The charging member 18 uniformly charges the image bearing member 14, and the optical writing device (not shown) emits a laser light beam to irradiate the surface of the image bearing member 14 so that an electrostatic latent image can be formed on the surface of the image bearing member 14. The developing device 12 supplies the developer 34 to the electrostatic latent image formed on the surface of the image bearing member 14. The developer 34 supplied from the developing device 12 adheres on the electrostatic latent image under a predetermined level of a developing bias potential so that the electrostatic latent image can be developed to a visible toner image. While an intermediate transfer bias potential is applied to the developer 34 on the visible toner image formed on the surface of the image bearing member 14, the primary transfer member 16 transfers the visible toner image onto a surface of the intermediate transfer member 24. Then, the secondary transfer member (not shown) transfers the visible toner image formed on the intermediate transfer member 24 onto the recording medium 22. The toner image on the recording medium 22 is then fixed with heat and pressure by the fixing device 26. The recording medium 22 is then conveyed in a direction indicated by arrow A in FIG. 1. The recording medium 22 fixed with the developer of the visible toner image is then discharged from the image forming apparatus 100.

The development cartridge 10, shown in FIG. 1 according to the exemplary embodiment of the present invention, can be integrated by the developing device 12 with the image bearing member 14 or can be separated from the image bearing member 14. The development cartridge 10 may be detachable with respect to the image forming apparatus 100.

FIG. 2 shows an enlarged view of the developing device 12 according to the exemplary embodiment of the present invention.

The developing device 12 supplies the developer 34 to the photoconductive element 14 (see FIG. 1) having an electrostatic latent image on the surface thereof. The developing device 12 includes a developer accommodating chamber 28 and a developing chamber 30.

The developer accommodating chamber 28 accommodates the developer 34 that serves as a one-component nonmagnetic developer. The developer 34 is conveyed from the developer accommodating chamber 28 to a developer supplying member 36 in synchronization with rotations of a developer conveying member 32 in a direction indicated by arrows in FIGS. 1 and 2. After being conveyed to the developer supplying member 36, the developer 34 is supplied to a developer bearing member 38 in synchronization with rotations of the developer supplying member 36.

A partition wall 40 is disposed between the developer accommodating chamber 28 and the developing chamber 30 so that the developer 34 can be stored in the developing chamber 30 to provide images with a predetermined density of developer.

Developer paths 44 are formed in the vicinity of both ends of the partition wall 40 to impart communications of the developer 34 passing from the developing chamber 30 to the developer accommodating chamber 28. The developer paths 44 shown in FIG. 2 according to the exemplary embodiment of the present invention have a form of a rectangular notch, a height of each of which runs from a top end portion (not shown) to a bottom portion 46 of the partition wall 40.

A layer thickness regulating member 42 is disposed at a bottom plate of the developing chamber 30. Specifically, the layer thickness regulating member 42 has one end in the longitudinal direction being fixedly disposed at a position lower than the developer bearing member 38 in the developing device 12 and the other end extending in an upward direction to the developer supplying member 36. The layer thickness regulating member 42 has a point thereon that is held in contact with a surface of the developer bearing member 38. Hereinafter, the above-described point is referred to as a “contact point”, and a predetermined height of the contact point of the layer thickness regulating member 42 and the developer bearing member 38 is referred to as a “height H0.” The layer thickness regulating member 42 regulates the layer thickness of the developer 34 supplied on the surface of the developer bearing member 38 so that the amount of the developer 34 on the developer bearing member 38 can be regulated. At the contact point of the developer bearing member 38 and the layer thickness regulating member 42, the developer 34 is conveyed thereto in synchronization with rotations of the developer bearing member 38 while being applied with a predetermined electric charge by friction with the layer thickness regulating member 42.

The developer supplying member 36 is coated by a resilient foam member having a plurality of holes. This structure can obtain a given amount of developer on the coated surface of the developer supplying member 36, and can prevent the developer 34 from deteriorating due to an increase of intensity of biased pressure exerted by contacting with the developer bearing member 38. A conductive material including carbon particles can be used as the resilient foam member for the developer supplying member 36. The value of electrical resistance of the resilient foam member can be set within a range of from approximately 10³Ω to approximately 10¹²Ω. The developer supplying member 36 is rotated in a direction indicated by an arrow in the developer supplying member 36 shown in FIG. 2 so that the developer 34 on the surface of the developer supplying member 36 can be effectively supplied to the surface of the developer bearing member 38.

The developer bearing member 38 includes a central shaft (not shown) covered by a layer of elastic rubber. The surface of the elastic rubber layer is coated with a material charged with a polarity opposite to the developer 34. The elastic rubber layer has a hardness of approximately 60 degrees (JIS-A: JIS K 6301) so that the developer 34 may not deteriorate due to the pressure exerted by a contact of the developer 34 and the layer thickness regulating member 42. Details of the layer thickness regulating member 42 will be described later.

The surface roughness of the developer bearing member 38 is determined such that the radius (Ra) of the developer bearing member 38 falls in a range from approximately 0.3 μm to approximately 2.0 μm. By setting the radius of the developer bearing member 38 within the above-described range, the developer bearing member 38 can carry a sufficient amount of the developer 34 for developing an electrostatic latent image at an appropriate density of developer. The developer bearing member 38 is applied with an appropriate developing bias to form an electric field between the developer bearing member 38 and the image bearing member 14. Therefore, the elastic rubber layer of the developer bearing member 38 also includes a conductive material. In the exemplary embodiment of the present invention, the value of electrical resistance of the elastic rubber layer can be set within a range from approximately 10³Ω to approximately 10¹⁰Ω. The developer bearing member 38 is rotated in a direction indicated by an arrow in the developer bearing member 38 shown in FIG. 2 so that the developer 34 supplied on the surface of the developer bearing member 38 can be conveyed to the contact point of the developer bearing member 38 and the layer thickness regulating member 42.

In the developing device 12 according to the exemplary embodiment of the present invention, the direction of rotations of the developer supplying member 36 is not limited to the above-described direction. The developer supplying member 36 can be rotated in the clockwise direction or in the counterclockwise direction as long as the developing device 12 is designed to perform an appropriate developing operation.

The layer thickness regulating member 42 serves as a regulating member in a form of a regulating blade. The layer thickness regulating member 42 is disposed at a predetermined position lower than a nip portion of the developer supplying member 36 and the developer bearing member 38 in the developing device 12 according to the exemplary embodiment of the present invention so as to reduce the entire size of the developing device 12. Specifically, if the layer thickness regulating member 42 is disposed at the above-described position, then the height of the entire developing device 12 can be reduced or moderated, when compared to a case in which a layer regulating member is formed in a roller or a case in which a layer regulating member extends from an upper portion of the developing device 12 toward the developer bearing member 38.

The layer thickness regulating member 42 can include materials that can apply a charge by friction with respect to the developer 34. Specific examples of the materials are stainless steel, phosphor bronze and the like. As previously described, the layer thickness regulating member 42 used in the developing device 12 according to the exemplary embodiment shown in FIG. 2 has one end fixedly disposed at the bottom plate of the developing chamber 30 and the other end, which is a free end, extending in an upward direction toward the developer supplying member 36. The free end extends over the contact point of the developer bearing member 38 and the layer thickness regulating member 42. The layer thickness regulating member 42 is elastically held in contact with the developer bearing member 38 with an angle of a predetermined degree in which the linear load thereof falls in a range of a pressure from approximately 10 N/m to approximately 40 N/m.

The length of the layer thickness regulating member 42 is not limited. The layer thickness regulating member 42 can be disposed in contact with the developer bearing member 38 at the contact point. The free end of the layer thickness regulating member 42 can extend in an upward direction toward the developer supplying member 36 so that the developer 34 supplied from the developer supplying member 36 can be conveyed to a gap formed between the developer bearing member 38 and the layer thickness regulating member 42. When the layer thickness regulating member 42 is arranged in the above-described manner, the length thereof can be adjusted to any value.

The layer thickness regulating member 42 is applied with a regulating bias. The regulating bias is determined as an offset voltage having a same charge polarity as the developer 34 that is applied with the developing bias so as to increase the charging ability by friction.

Referring to FIG. 3, a cross sectional view of the structure of the developing device 12 of FIG. 2 according to the exemplary embodiment of the present invention is described. The developing device 12 of FIG. 3 is viewed across the cross section line B-B shown in FIG. 2.

In FIG. 3, the developing device 12 includes the partition wall 40. As previously described, the partition wall 40 is disposed between the developing chamber 30 and the developer accommodating chamber 28. The partition wall 40 includes a center portion having a predetermined height to store a sufficient amount of the developer 34 so that the developing operation can be performed under a stable condition in the developing chamber 30. The predetermined height at the center portion of the partition wall 40 is hereinafter referred to as a “height H1” as shown in FIG. 3.

The partition wall 40 also includes both ends to form the respective developer paths 44. As previously described, the developer paths 44 are formed to smoothly impart and further increase fluidity of the developer 34 around the layer thickness regulating member 42 disposed in the developing chamber 30.

Each of the developer paths 44 shown in FIG. 3 is formed as a notch shaped like a rectangle in the vicinity of both ends of the partition wall 40. Each of the bottom portions 46 of the developer paths 44 is arranged to have a predetermined height. The predetermined height of the bottom portions 46 of the developer paths 44 is hereinafter referred to as a “height H2” as shown in FIG. 3. The height H2 of the developer paths 44 is positioned at a location lower than the height H0, which is the height of the contact point of the developer bearing member 38 (see FIG. 2) and the layer regulating member 42 (see FIG. 2). The developer 34, which is stored in the developing chamber 30 along with the developing processes, passes through the developer paths 44 to be conveyed to the developer accommodating chamber 28. Therefore, the amount of the developer 34 in the vicinity of both ends of the partition wall 40 can be more reduced when compared with the amount of the developer 34 accumulated in the vicinity of the center portion of the partition wall 40. As a result, the amount of the developer 34 in the developing chamber 30 may be gradually reduced toward the partition wall 40 so that the excess amount of the developer 34 accumulated along the layer thickness regulating member 42 in the developing chamber 30 can be returned to the developer accommodating chamber 28 via the developer paths 44.

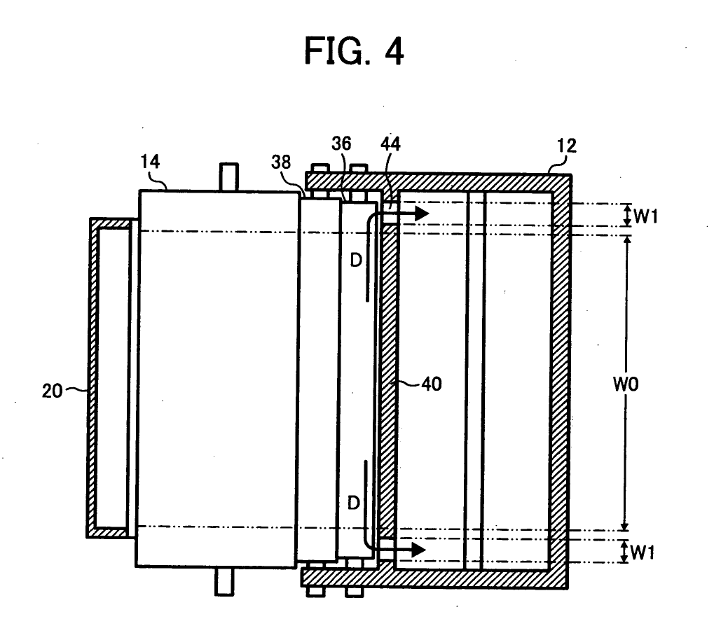

Referring to FIG. 4, a cross sectional view of the structure of the image forming apparatus 100 of FIG. 1 that includes the developing cartridge 10 according to the exemplary embodiment of the present invention is described. The image forming apparatus 100 of FIG. 4 is viewed across the cross section line C-C shown in FIG. 1.

FIG. 4 shows positions of the developing device 12 and an image forming area of the image bearing member 14. As shown in FIG. 4, the width of the image forming area is hereinafter referred to as a “width W0.” Areas that lie outside the image forming area have respective widths. Each of the widths start from a predetermined position outside the both ends of the image forming area. These widths of the above-described areas represent respective widths of the developer paths 44 of the partition wall 40. Each of the widths is hereinafter referred to as a “width W1.”

In the developing device 12 according to the exemplary embodiment of the present invention, when the developer supplying member 36 is rotated, the developer 34 is being conveyed toward the layer thickness layer regulating member 42 (see FIG. 2). Thereby, the developer 34 that is accumulated in the vicinity of the partition wall 40 of the developing chamber 30 is conveyed in a direction indicated by arrows D in FIG. 4. When the developer 34 comes to the developer paths 44, the developer 34 is further conveyed or returned to the developer accommodating chamber 28. The above-described structure can reduce or avoid the developer 34 that intensively gathers in the developing chamber 30, especially into a specific space thereof formed by the layer thickness regulating member 42, the developer supplying member 36, the partition wall 40, and the bottom plate of the developing device 12.

The shape and structure of the developer paths 44 are not limited. As previously described, the developer paths 44 can be arranged at the above-described position with the widths W1 with respect to the image forming area of the image bearing member 14 with the width W0. The developer paths 44 can also be arranged at the above-described position with the heights H1 and H2 with respect to the height H0 of the contact point of the developer bearing member 38 and the layer thickness regulating member 42. When the developer paths 44 are arranged under the above-described relationships, the shape and structure thereof can be adjusted to any value. The shape and structure of the developer paths 44 are applicable if each of the developer paths 44 is designed to run through the partition wall 40 in a direction of its thickness. For example, the developer paths 44 can be notches having a shape of a rectangle, plane trapezoid, plane triangle and the like, a slit extending in a vertical or horizontal direction, a through hole and the like.

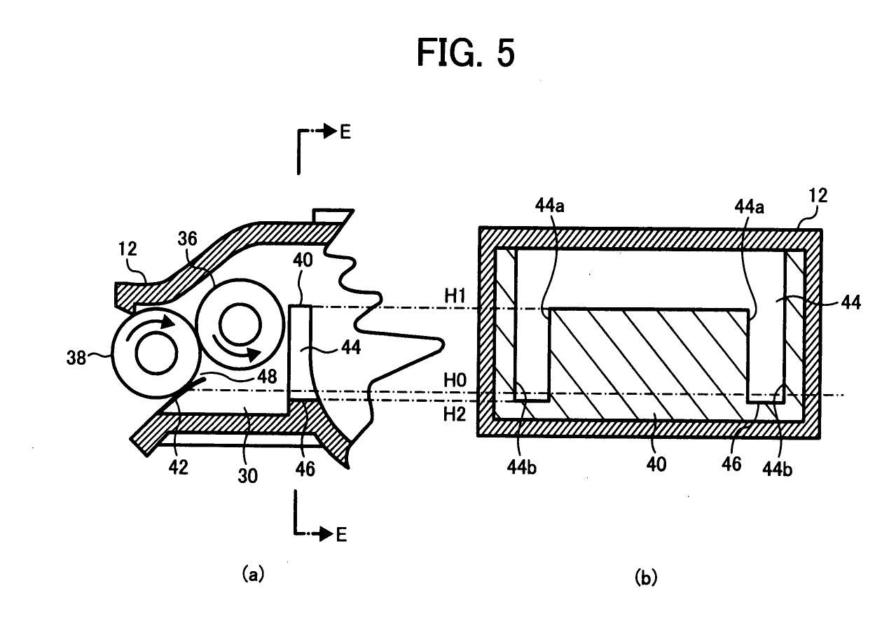

Referring to FIGS. 5(a) and 5(b), a relationship of the exemplary developer paths 44 and the contact point of the developer bearing member 38 and the layer thickness regulating member 42 in the developing chamber 30 of the developing device 12 according to a first example of the exemplary embodiment of the present invention is described. Details of the first example of the exemplary embodiment of the present invention will be described later as “Example 1.”

FIG. 5(a) is a cross sectional view of the structure of the developing device 12 in the vicinity of the developing chamber 30, and FIG. 5(b) is a cross sectional view of the structure of the developing device 12 across the cross section line E-E in FIG. 5(a).

Hereinafter, cross sectional drawings similar to FIGS. 5(a) and 5(b) are shown later to describe examples and comparative examples of exemplary developing paths of the present invention. It should be noted that the heights described hereinafter are measured from the bottom portion of the developing chamber 30.

As shown in FIG. 5(a), the partition wall 40 has the height H1 at the central portion. Further, as shown in FIG. 5(b), the partition wall 40 includes the developer paths 44 having a shape of a rectangular notch. Each of the developer paths 44 has the height H2 that is measured from the bottom portion of the developing chamber 30.

The height H2 may be determined to be lower than the height H0, which is the height of the contact point of the developer bearing member 38 and the layer thickness regulating member 42. The heights H0, H1, and H2 may satisfy the relationship of H1>H0>H2 according to the first example of the exemplary embodiment of the present invention.

Further, in the developing device 12 according the first example of the exemplary embodiment of the present invention, there are various ways to regulate the height H0 representing the height of the contact point of the developer bearing member 38 and the layer thickness regulating member 42.

For example, the height H0 can be determined as a height measured from the bottom portion of the developing chamber 30 up to an intermediate position of the layer thickness regulating member 42, which is a point on the surface of the developer bearing member 38 contacting the layer thickness regulating member 42.

Further, the height H0 can be determined to be a height of a point having the highest contact pressure exerted between the developer bearing member 38 and the layer thickness regulating member 42. Furthermore, the height H0 can be determined as a height of the bottom portion of a pocket 48 that is a specific space formed due to a contact of the developer bearing member 38 and the layer thickness regulating member 42.

Further, the relationship between the heights H0 and H2 in this exemplary embodiment of the present invention can be expressed as (H0−H2) =10 mm. However, in view of respective diameters of particles of the developer and fluidity of the developer, the value obtained from the relationship expressed by (H0−H2) is not limited as long as the relationship of (H0−H2)>0 is satisfied.

In the developing device 12 of FIGS. 5(a) and 5(b) according to the first example of the exemplary embodiment of the present invention, respective inner ends 44a of the developer paths 44, formed in a width direction of the developer paths 44, can be arranged outside both ends of the image forming area in the width direction with the width W0. Specifically, the respective inner ends 44a of the developer paths 44 can be arranged at respective positions that do not affect the amount of the developer 34 supplied within the image forming area.

Respective outer ends 44b of the developer paths 44, formed in the width direction of the developer paths 44, can be arranged at respective positions corresponding to the both ends of the image forming area in the width direction. Specifically, the respective outer ends 44b of the developer paths 44 can be arranged at respective positions to which the developer 34 stored in the developing chamber 30 of the developing device 12 is not necessarily supplied. In the developing device 12 according to the first example of the exemplary embodiment of the present invention, the positions of the outer ends 44b in the width direction of the image forming area are not limited as long as the outer ends 44b do not affect the printed images, the drives of the developer supplying member 36 and the developer bearing member 38, and the amount of the consumed developer 34.

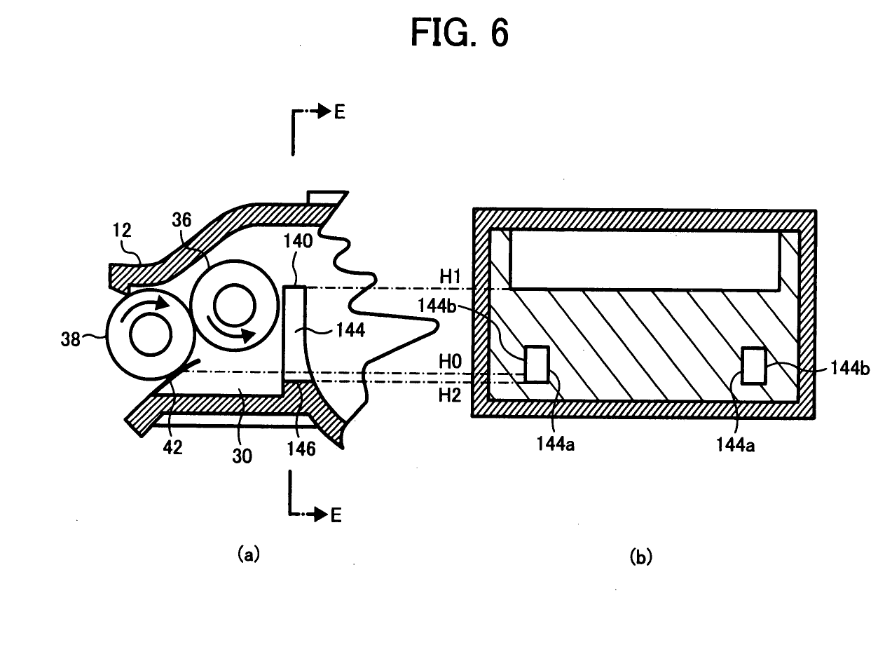

Referring to FIGS. 6(a) and 6(a), a relationship of different exemplary developer paths 144 and the contact point of the developer bearing member 38 and the layer thickness regulating member 42 in the developing chamber 30 of the developing device 12 according to a second example of the above-described exemplary embodiment of the present invention is described. Details of the second example of the exemplary embodiment of the present invention will be described later as “Example 2.”

FIG. 6(a) is a cross sectional view of the structure of the developing device 12 in the vicinity of the developing chamber 30, and FIG. 6(b) is a cross sectional view of the structure of the developing device 12 across the cross section line E-E in FIG. 6(a).

The developing device 12 of FIG. 6(a) according to the second example of the exemplary embodiment of the present invention includes a partition wall 140 having the height H1 at the central portion thereof. The functions and structure including the heights and widths of the developing device 12 of FIGS. 6(a) and 6(b) are basically similar to those shown in FIGS. 5(a) and 5(b) according to the first example of the exemplary embodiment of the present invention, except that the partition wall 140 includes the different exemplary developer paths 144 in a form of a rectangular opening. Each of the developer paths 144 of a rectangular opening includes a bottom portion 146 having the height H2 that is lower than the height H0 so as to satisfy a relationship of H1>H0>H2. The rectangular openings in respective inner and outer ends 144a and 144b in the width direction are arranged at respective positions that are the same as the positions described in the developing device 12 according to the first example of the exemplary embodiment of the present invention.

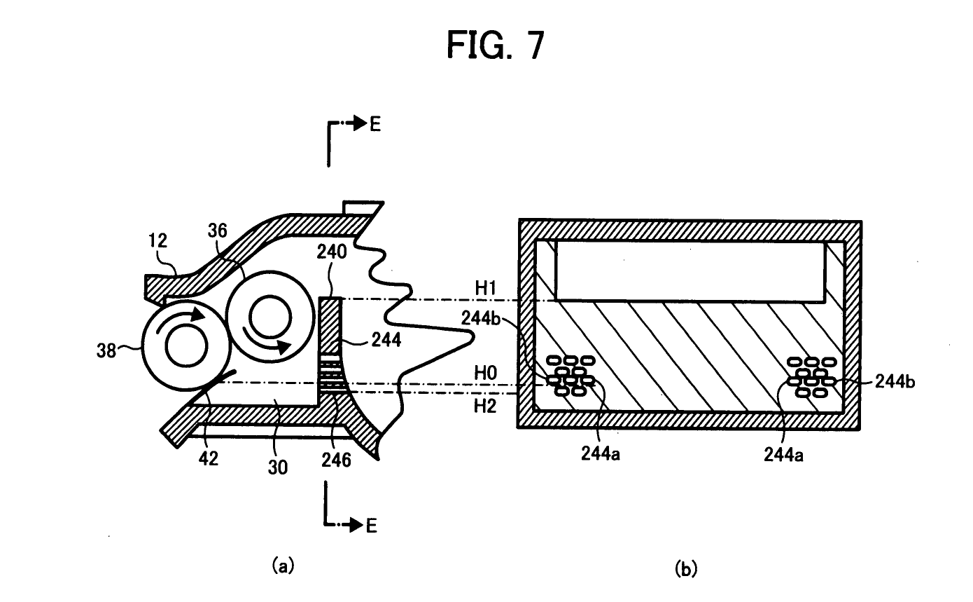

Referring to FIGS. 7(a) and 7(b), a relationship of different exemplary developer paths 244 and the contact point of the developer bearing member 38 and the layer thickness regulating member 42 in the developing chamber 30 of the developing device 12 according to a third example of the above-described exemplary embodiment of the present invention is described. Details of the third example of the exemplary embodiment of the present invention will be described later as “Example 3.”

FIG. 7(a) is a cross sectional view of the structure of the developing device 12 in the vicinity of the developing chamber 30, and FIG. 7(b) is a cross sectional view of the structure of the developing device 12 across the cross section line E-E in FIG. 7(a).

The developing device 12 of FIG. 7(a) according to the third example of the exemplary embodiment of the present invention includes a partition wall 240 having the height H1 at the central portion thereof. The functions and structure including the heights and width of the developing device 12 of FIGS. 7(a) and 7(b) are basically similar to those shown in FIGS. 5(a) and 5(b) according to the first example of the exemplary embodiment of the present invention, except that the partition wall 240 includes the different exemplary developer paths 244 as a pair of plural strings of oval-shaped through holes at both ends of the partition wall 240.

The pair of plural strings of oval-shaped through holes is arranged such that a lowermost through hole of the plural strings of oval-shaped through holes includes a bottom portion 246 having the height H2 that is lower than the height H0 so as to satisfy the relationship of H1>H0>H2. Further, respective inner ends 244a of the oval-shaped through holes that reside at respective innermost position in the width direction of the partition wall 240 are disposed outside both ends of the image forming area in the width direction. The oval-shaped through holes having respective outer ends 244b are determined to reside at respective outermost position in the width direction of the partition wall 240.

In the developing device 12 according to the third example of the exemplary embodiment of the present invention, the shape of the through holes of the developer paths 244 as shown in FIGS. 7(a) and 7(b) are formed in a substantially oval shape. However, the shape of the through holes of the developer paths 244 is not limited to the oval shape. For example, each of the developer paths 244 according to the third example of the exemplary embodiment of the present invention is applicable to form in combination of a rectangular shape, a circular or round shape, a vertically long slit, a horizontally long slit, an inclined slit and so forth. Further, the developer paths 244 according to the third example of the exemplary embodiment of the present invention are not limited in the number, size and intervals of through holes.

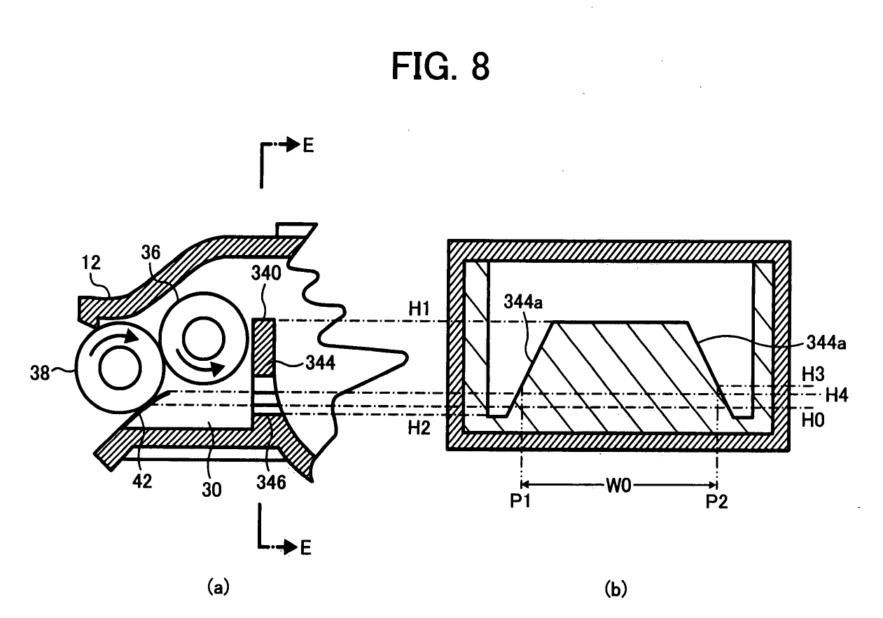

Referring to FIGS. 8(a) and 8(b), a relationship of different developer paths 344 and the contact point of the developer bearing member 38 and the layer thickness regulating member 42 in the developing chamber 30 of the developing device 12 according to a fourth example of the exemplary embodiment of the present invention is described. Details of the fourth example of the exemplary embodiment of the present invention will be described later as “Example 4.”

FIG. 8(a) is a cross sectional view of the structure of the developing device 12 in the vicinity of the developing chamber 30, and FIG. 8(b) is a cross sectional view of the structure of the developing device 12 across the cross section line E-E in FIG. 8(a).

The developing device 12 of FIG. 8(a) according to the fourth example of the exemplary embodiment includes a partition wall 340 having the height H1 at the central portion thereof. The functions and structure including the heights and widths of the developing device 12 of FIGS. 8(a) and 8(b) are basically similar to those shown in FIGS. 5(a) and 5(b) according to the first example of the exemplary embodiment of the present invention, except that the partition wall 340 includes the different exemplary developer paths 344 in a form of a trapezoidal notch at both ends of the partition wall 340. The trapezoidal notch has an upper base line thereof longer than a lower base line thereof, as shown in FIG. 8(b). Each of the developer paths 344 includes a bottom portion 346 having the height H2 that is lower than the height H0. Each of respective inner ends 344a of the developer paths 344 is downwardly tapered in a direction outside both ends in the width direction of the image forming area having the width W0. Further, the heights of respective bottom portions 346 of the developer paths 344 are designed to satisfy the relationship of H1>H0>H2. In FIGS. 8(a) and 8(b), the width W0 of the image forming area is regulated to be located between both ends P1 and P2 of the image forming area of the image bearing member 14.

In the developing device 12 according to the present invention, respective values of the angle at the tapered line of the inner ends 344a, the lengths of the upper and lower base lines, and the inner ends 344a of the trapezoidal notch are not limited as long as the bottom portions 346 of the developer paths 344, which is located at a position having the height H2, can be arranged outside the image forming area having the width W0 in the width direction and can satisfy the relationship of H1>H0>H2.

As an alternative, the partition wall 340 of the fourth example of the exemplary embodiment of the present invention can be formed such that the upper base line is shorter than the lower base line.

Further, as an alternative, the inner ends 344a of the developer paths 344 of the fourth example of the exemplary embodiment of the present invention can be formed as a plurality of serial different shapes of rectangular notches, curved lines, or a combination of series of inclined lines and so forth.

In the developing device 12 shown in FIGS. 8(a) and 8(b), the position of the inner ends 344a in the width direction of the developer paths 344 can be changed according to the height of the position thereof. When the respective heights H2 of the bottom portions 346 are lower than the height H0, which is the height of the contact point, or when the respective heights of the inner ends 344a within the image forming area are lower than a predetermined height of the free end of the layer thickness regulating member 42, there is the possibility that a sufficient amount of the developer 34 is not sufficiently supplied. The predetermined height of the free end of the layer thickness regulating member 42 is hereinafter referred to as a “height H4.” Therefore, when the respective positions of the inner ends 344a of the developer paths 344 change in the width direction, the inner ends 344a of the developer paths 344 are controlled to have respective predetermined heights that can become equal to or greater than the predetermined height or the height H4 of the free end of the layer thickness regulating member 42. The respective predetermined heights of the inner ends 344a of the developer paths 344 are hereinafter referred to as “heights H3.” Specifically, the respective heights H3 and the height H4 satisfy the relationship of H3≧H4.

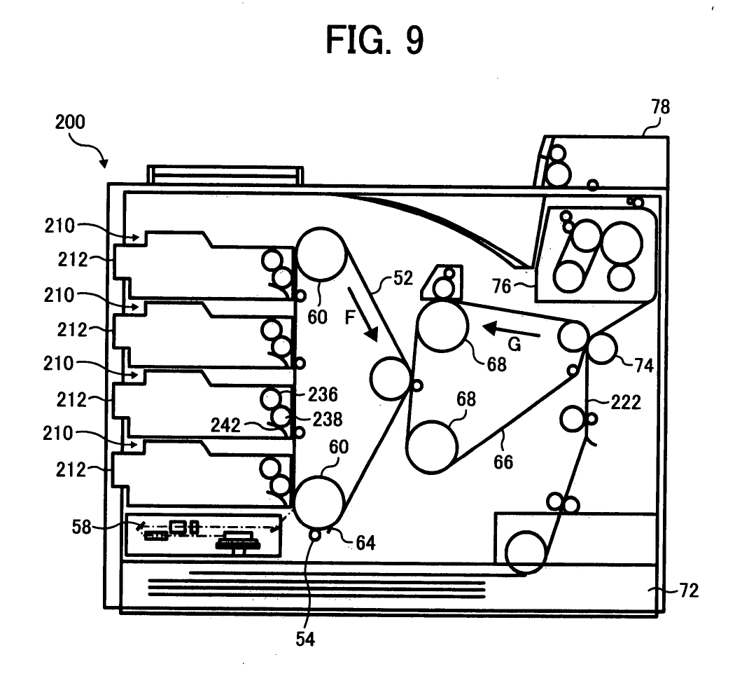

Referring to FIG. 9, FIG. 9 shows an image forming apparatus 200 including a plurality of developing devices 212 according to an alternative exemplary embodiment of the present invention.

In the image forming apparatus 200 of FIG. 9, a plurality of development cartridges 210 including the plurality of respective developing devices 212 correspond to the number of different developers, such as cyan, magenta, yellow, and black. The plurality of development cartridges 210 are disposed in a vertical direction to print a full color image. Each of the plurality of developing devices 212 includes a partition wall (not shown in FIG. 9) with corresponding developer paths (not shown in FIG. 9) and a layer thickness regulating member 242. The layer thickness regulating member 242 is disposed at a position lower than the contact point of a developer bearing member 238 and a developer supplying member 236. When a print command is sent from an external or internal controller (not shown) of the image forming apparatus 200, a conveying roller 60 drives an image bearing member 52 in a shape of an endless belt to rotate in a direction indicated by arrow F. A cleaning blade 64 removes residual toner on the image bearing member 52. Then, a charging member 54, such as a charging roller, charges the surface of the image bearing member 52, and a semiconductor laser (not shown) emits a laser beam toward the image bearing member 52. The laser beam is reflected by a polygon mirror 56 rotating at a high speed, a reflection mirror 58, and an f-theta lens 62 and the like, before exposing the surface of the image bearing member 52.

When the image bearing member 52 is exposed to the laser beam emitted by the semiconductor laser, an electrostatic latent image with a specific color according to image data is formed on the surface of the image bearing member 52. Each of the developing devices 212 corresponding to respective different colors develops the electrostatic latent image to a visible toner image. The toner image is transferred onto an intermediate transfer member 66 conveyed by conveying rollers 68 in a direction indicated by arrow G. Then, the toner image is further transferred by a transfer roller 74 applied with a transfer bias voltage onto a recording medium 222 conveyed from a sheet feeding unit 72. Next, the recording medium 222 having the toner image on one side thereof is fixed by a fixing unit 76 and is conveyed via a sheet discharging unit 78 to be discharged outside the image forming apparatus 200 as a full color image.

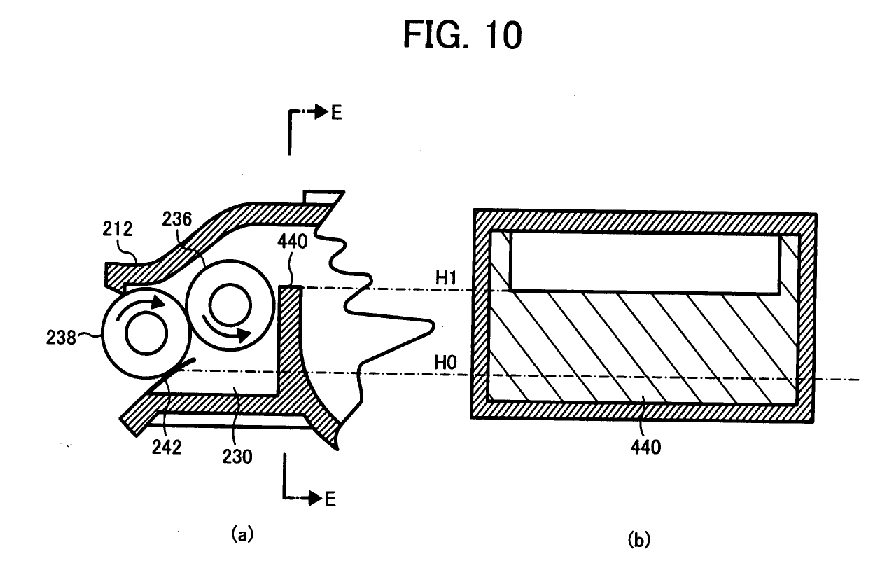

Referring to FIGS. 10(a) and 10(b), the developing device 212 according to a first example or “Comparative Example 1” of the alternative exemplary embodiment of the present invention is described.

FIG. 10(a) is a cross sectional view of the structure of the developing device 212 in the vicinity of a developing chamber 230, and FIG. 10(b) is a cross sectional view of the structure of the developing device 212 across the cross section line E-E in FIG. 10(a).

The developing device 212 of FIG. 10(a) according to the first example of the alternative exemplary embodiment of the present invention includes a partition wall 440 having no developer path. Specifically, the partition wall 440 includes the height H1 at the central portion thereof. The structure and functions of the developing device 212 are basically similar to those of the developing device 12 shown in FIGS. 5(a) and 5(b) according to the first example of the previously described exemplary embodiment of the present invention, except that the partition wall 440 has no developer paths. The developer paths generally can be arranged on the partition wall 440 at respective positions lower than the height H0 that is a height of a contact point of the developer bearing member 238 and a layer thickness regulating member 242 in the developing chamber 230.

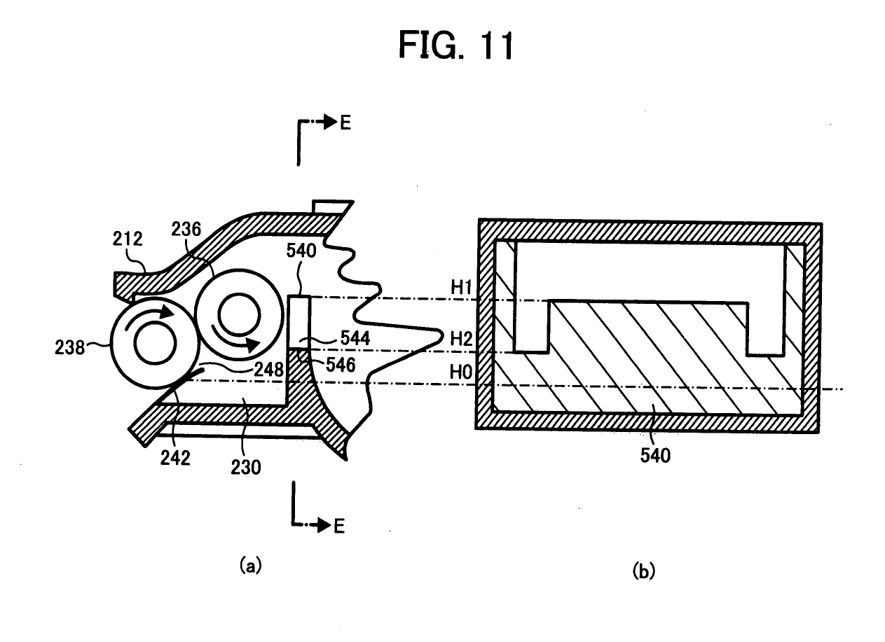

Referring to FIGS. 11(a) and 11(b), a relationship of different exemplary developer paths 544 and the contact point of the developer bearing member 238 and the layer thickness regulating member 242 in the developing chamber 230 of the developing device 212 according to a second example or “Comparative Example 2” of the alternative exemplary embodiment of the present invention is described.

FIG. 11(a) is a cross sectional view of the structure of the developing device 212 in the vicinity of a developing chamber 230, and FIG. 11(b) is a cross sectional view of the structure of the developing device 212 across the cross section line E-E in FIG. 11(a).

The developing device 212 of FIG. 11(a) according to the second example of the alternative exemplary embodiment of the present invention includes a partition wall 540 having the height H1 at the central portion thereof. The functions and structure, including the heights and widths of the developing device 212 of FIGS. 11(a) and 11(b), are basically similar to those shown in FIGS. 10(a) and 10(b) according to the first example of the alternative exemplary embodiment of the present invention. Except the partition wall 540 includes the different exemplary developer paths 544 in a shape of a rectangular notch. Each of the developer paths 544 includes a bottom portion 546 having the height H2 that is upper than the height H0, which satisfies a relationship of H0 <H2.

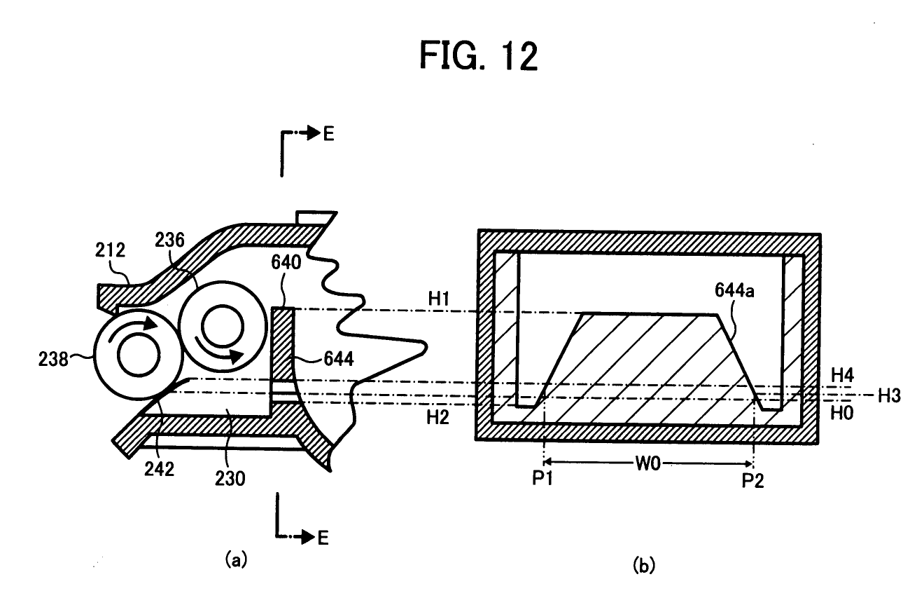

Referring to FIGS. 12(a) and 12(b), a relationship of different developer paths 644 and the contact point of the developer bearing member 238 and the layer thickness regulating member 242 in the developing chamber 230 of the developing device 212 according to a third example or “Comparative Example 3” of the alternative exemplary embodiment of the present invention is described.

FIG. 12(a) is a cross sectional view of the structure of the developing device 212 in the vicinity of a developing chamber 230, and FIG. 12(b) is a cross sectional view of the structure of the developing device 212 across the cross section line E-E in FIG. 12(a).

The developing device 212 of FIG. 12(a) according to the third example of the alternative exemplary embodiment of the present invention includes a partition wall 640 having the height H1 at the central portion thereof. The functions and structure, including the heights and widths of the developing device 212 of FIGS. 12(a) and 12(b), are basically similar to those shown in FIGS. 10(a) and 10(b) according to the first example of the alternative exemplary embodiment of the present invention. Except the partition wall 640 includes the different exemplary developer paths 644 in a form of a trapezoidal notch at both ends of the partition wall 340, which is similar to the exemplary developer paths 344 according to the fourth example of the previously described exemplary embodiment of the present invention. The trapezoidal notch has an upper base line thereof longer than a lower base line thereof, as shown in FIG. 12(b). Each of the developer paths 644 includes a bottom portion 646 having the height H2 that is lower than the height H0. Each of respective inner ends 644a of the developer paths 644 is downwardly tapered in a direction outside both ends in the width direction of the image forming area having the width W0. Further, the heights of respective bottom portions 646 of the developer paths 344 are designed to satisfy the relationship of H1>H0>H2. In FIGS. 12(a) and 12(b), the width W0 of the image forming area is regulated to be located between both ends P1 and P2 of the image forming area of the image bearing member 14.

In the developing device 212 according to exemplary embodiments of the present invention, respective values of the angle at the tapered line of the inner ends 644a, the lengths of the upper and lower base lines, and the inner ends 644a of the trapezoidal notch are not limited as long as the bottom portions 646 of the developer paths 644, which is located at a position having the height H2, can be arranged outside the image forming area having the width W0 in the width direction and can satisfy the relationship of H1>H0>H2.

As an alternative, the partition wall 640 of the third example of the alternative exemplary embodiment of the present invention can be formed such that the upper base line is shorter than the lower base line.

Further, as an alternative, the inner ends 644a of the developer paths 644 of the third example of the alternative exemplary embodiment of the present invention can be formed as a plurality of serial different shapes of rectangular notches, curved lines, or a combination of series of inclined lines and so forth.

In the developing device 212 shown in FIGS. 12(a) and 12(b), when the respective heights H2 of the bottom portions 646 are lower than the height H0 or when the respective heights of the inner ends 644a within the image forming area are higher than the predetermined height H4 of the free end of the layer thickness regulating member 242, there are possibilities that the sufficient amount of the developer 34 are not sufficiently supplied. Therefore, when the respective positions of the inner ends 644a of the developer paths 644 change in the width direction, the inner ends 644a of the developer paths 644 are controlled to have the respective predetermined heights H3 that can become smaller than the predetermined height H4 of the free end of the layer thickness regulating member 242. Specifically, the respective heights H3 and the height H4 can satisfy the relationship of H3<H4.

The following shows experimental examples according to the above-described exemplary embodiments of the present invention. However, the present invention is not limited to the examples described below.

### EXAMPLE 1

A developing device, that is a commercially available full color printer using one-component nonmagnetic developer, was modified to meet the developing device 212 shown in FIG. 9 of the exemplary embodiment of the present invention. In the following experiments, the modified device meeting the developing device 212 was used and the processes and results were obtained through the experiments with the developing device 212. However, the experiments can also be performed by a developing device modified to the developing device 12.

The housing of the developing device 212 of the commercial full color printer was disassembled and modified to dispose the layer thickness regulating member 242 made of a SUS 304 stainless steel with a thickness of approximately 0.1 mm. The layer thickness regulating member 242 was disposed and screwed at the bottom plate of the housing with a contact pressure of approximately 10 N/m to approximately 40 N/m in linear load so that the position of the layer thickness regulating member 242 became lower than the contact point of the developer bearing roller 238 and the developer supplying roller 236. After the developer supplying roller 236 and the developer bearing roller 238 were mounted, the height of the contact point (height H0) of the developer bearing roller 238 and the layer thickness regulating member 242 and the height of the free end (height H4) of the layer thickness regulating member 242 at the moment were measured. The partition wall 40 in Example 1 was formed to include the respective developer paths 44 in a form of a rectangular notch at both ends thereof. The bottom portions 46 of the respective developer paths 44 were formed to be approximately 10 mm lower than the height H0 of the contact point of the developer bearing member 238 and the layer thickness regulating member 242. The respective inner sides 44a of the rectangular shaped developer paths 44 were positioned outside the image forming area of the image forming apparatus 200. Then, the partition wall 40 was fixedly mounted on the developing device 212. Thus, the developing device 212 was made with the partition wall 40 having the developer paths 44 formed in the shape shown in FIGS. 5(a) and 5(b).

The thus modified developing device 212 was filled with approximately 180 g of the commercially available one-component nonmagnetic developer, substantially corresponding to approximately 80% in volume of the developer accommodating chamber. The developing device 212 filled with the above-described developer 34 is attached to the commercial full color printer having the structure shown in FIG. 9. Then, a continuous print test for durability was performed under conditions with a room temperature of approximately 25□C and a relative humidity (RH) of approximately 55%. By continuously running 8,000 sheets of paper for printing, image noises (noise streaks and/or unevenness on image) and density levels on images were visually observed to evaluate characteristics of the developing device 212 according to the first example of the exemplary embodiment of the present invention. In the continuous print test for durability, a test pattern with image area coverage of 5% was used.

The image noises were evaluated by visually observing noise streaks and/or unevenness on image generated on the test patterns printed on the sheets. Based on the visual observation, the results were ranked as follows:

“VERY POOR”: noise streaks and/or unevenness on image occurred after printing less than or equal to 500 sheets;

“POOR”: noise streaks and/or unevenness on image occurred while printing 500 sheets to 1,500 sheets; and

“GOOD”: noise streaks and/or unevenness on image did not occur up to 8,000 sheets.

When low level of image density was observed in the visual observation of the continuous print test for durability, the evaluation fell on “POOR”, regardless of the number of printed sheets.

The developing device 212 with the partition wall 40 having the developer paths 44, according to the first example or Example 1 of the exemplary embodiment of the present invention, performed a good durable printing after continuously outputting 8,000 sheets of paper, without producing print sheets with the image noises, such as noise streaks and/or unevenness at respective ends of the printed images, toner contamination, and low level of image density. The result of the continuous print test for durability according to Example 1 of the exemplary embodiment of the present invention will be shown in Table 1, together with the structure of the developer paths 44 used therein.

### EXAMPLE 2

The structure and function of the developing device 212 according to the second example or Example 2 of the exemplary embodiment of the present invention were similar to those of the developing device 212 according to Example 1 of the present invention, except that the partition wall 140 of Example 2 was formed to include the respective developer paths 144 in a rectangular opening, instead of the rectangular notch in Example 1 of the present invention. The continuous print test for durability was performed on the developing device 212 with the partition wall 140 having the developer paths 144 according to Example 2 of the present invention to visually observe the image noises and density levels.

Same as the developing device 212 according to Example 1, the developing device 212 with the partition wall 140 having the developer paths 144, according to the second example or Example 2 of the exemplary embodiment of the present invention, performed a good durable printing after continuously outputting 8,000 sheets of paper, without producing print sheets with the image noises, such as noise streaks and/or unevenness, at respective ends of the printed images, toner contamination, and low level of image density. The result of the continuous print test for durability according to Example 2 of the present invention will be shown in Table 1, together with the structure of the developer paths used therein.

### EXAMPLE 3

The structure and function of the developing device 212 according to the third example or Example 3 of the exemplary embodiment of the present invention were similar to those of the developing device 212 according to Example 1, except that the partition wall 240 of Example 3 was formed to include the respective developer paths 244 as a pair of plural strings of oval-shaped through holes at both ends of the partition wall 240. The continuous print test for durability was performed on the developing device 212 according to Example 3 of the present invention to visually observe the image noises and density levels.

Same as the developing device 212 according to Example 1 of the present invention, the developing device 212 with the partition wall 240 having the developer paths 244, according to the third example or Example 3 of the exemplary embodiment of the present invention, performed a good durable printing after continuously outputting 8,000 sheets of paper, without producing print sheets with the image noises, such as noise streaks and/or unevenness, at respective ends of the printed images, toner contamination, and low level of image density. The result of the continuous print test for durability according to Example 3 of the present invention will be shown in Table 1, together with the structure of the developer paths used therein.

### EXAMPLE 4

The structure and function of the developing device 212 according to the fourth example or Example 4 of the exemplary embodiment of the present invention were similar to those of the developing device 212 according to Example 1, except that the partition wall 340 of Example 4 was formed to include the respective developer paths 344 in a form of a trapezoidal notch at both ends of the partition wall 340. As previously described, the trapezoidal notch was formed such that the upper base line thereof was longer than the lower base line thereof. Further, each of the inner sides 344a of the trapezoidal notch was designed to have an angle such that the height of the trapezoidal notch became higher than the height H4, which is the height of the free end of the layer thickness regulating member 242, within the image forming area. The continuous print test for durability was performed on the developing device 212 according to Example 4 to visually observe the image noises and density levels.

Same as the developing device 212 according to Example 1, the developing device 212 with the partition wall 340 having the developer paths 344, according to the fourth example or Example 4 of the exemplary embodiment of the present invention, performed a good durable printing after continuously outputting 8,000 sheets of paper, without producing print sheets with the image noises, such as noise streaks and/or unevenness, at respective ends of the printed images, toner contamination, and low level of image density. The result of the continuous print test for durability according to Example 4 of the present invention will be shown in Table 1, together with the structure of the developer paths used therein.

### COMPARATIVE EXAMPLE 1

The structure and function of the developing device 212 with the partition wall 440 with the developer paths 444 according to the Comparative Example 1 were similar to those of the developing device 212 according to Example 1, except that the partition wall 440 of Comparative Example 1 was formed to include no developer paths as shown in FIG. 10(b). The continuous print test for durability was performed on the developing device 212 according to Comparative Example 1 by running 8,000 sheets of paper to visually observe the image noises and density levels.

After 500 sheets of paper were run in the continuous print test for durability on the developing device 212 according to Comparative Example 1 of the present invention, the image noises including noise streaks and unevenness on image were observed on the print patterns on the images. Thus, good characteristics of the durable printing could not be obtained with the developing device 212 having the partition wall 440 as shown in FIGS. 10(a) and 10(b) according to Comparative Example 1. The result of the continuous print test for durability according to Comparative Example 1 of the present invention will be shown in Table 1, together with the structure of the developer paths used therein.

### COMPARATIVE EXAMPLE 2

The structure and function of the developing device 212 according to Comparative Example 2 were similar to those of the developing device 212 according to Example 1, except that the partition wall 540 of Comparative Example 2 was formed to include the respective developer paths 544 in a form in a rectangular notch as shown in FIG. 11(b). The respective bottom portions 546 of the rectangular shaped developer paths 544 were higher than the contact point of the developer bearing member 238 and the layer thickness regulating member 242, which specified the relationship of H0<H2. The continuous print test for durability was performed on the developing device 212 according to Comparative Example 2 by running 8,000 sheets of paper to visually observe the image noises and density levels.

The image noises in the vicinity of end portions of the printed images were reduced to a certain degree when using the developing device 212 having the partition wall 540 as shown in FIGS. 11(a) and 11(b) according to Comparative Example 2. However, image noises including noise streaks and unevenness on image were observed on the print patterns on the images after 1,500 sheets of paper were run in the continuous print test for durability on the developing device 212 according to Comparative Example 2 of the present invention. The occurrence of the image noises shows that the developing device 212 having the partition wall 540 with the structure shown in FIGS. 11(a) and 11(b) can reduce weak aggregation and/or blocking of the developer 34 to some extent at both ends of the developing device 212, but that the developing device 212 cannot sufficiently prevent image noises caused by the developer 34 gathered over the layer thickness regulating member 242. The result of the continuous print test for durability according to Comparative Example 2 of the present invention will be shown in Table 1, together with the structure of the developer paths 544 used therein.

### COMPARATIVE EXAMPLE 3

The structure and function of the developing device 212 according to Comparative Example 3 were similar to those of the developing device 212 according to Example 1, except that the partition wall 640 of Comparative Example 3 was formed to include the respective developer paths 644 in a form in a trapezoidal notch as shown in FIG. 12(b). The trapezoidal notch was formed such that the upper base line thereof was longer than the lower base line thereof. Further, the vertical height H3 of the inner sides 644a of the trapezoidal notch was designed to have an angle such that the height of the trapezoidal notch was formed to be lower than the height H4, which is the height of the free end of the layer thickness regulating member, within the image forming area, as shown in FIGS. 12(a) and 12(b). The continuous print test for durability was performed on the developing device 212 according to Comparative Example 2 by running 8,000 sheets of paper to visually observe the image noises and density levels.

During the continuous print test for durability, the developer 34 was not sufficiently supplied to both ends corresponding to specific areas that satisfy the relationship of H3<H4. Under the above-described circumstance, the low level of image density was observed at both ends of the printed images after the start of the continuous print test for durability. The result of the continuous print test for durability according to Comparative Example 3 of the present invention will be shown in Table 1, together with the structure of the developer paths 644 used therein.

TABLE 1

| | | EVALUATION |
|---|---|---|
| | | (25° C., 55% |
| EXAMPLES | SHAPE OF DEVELOPER PATH | RH) |
| EXAMPLE 1 | RECTANGULAR NOTCH | GOOD |
| | (H0 − H2) = 10 mm | |
| EXAMPLE 2 | RECTANGULAR OPENING | GOOD |
| | (H0 − H2) = 10 mm | |
| EXAMPLE 3 | STRINGS OF OVAL-SHAPED | GOOD |
| | THROUGH HOLES (H0 − | |
| | H2) = 10 mm | |
| EXAMPLE 4 | TRAPEZOIDAL NOTCH | GOOD |
| | (H0 − H2) = 10 mm, H3 ≧ H4 | |
| COMPARATIVE | NO DEVELOPER PATH | VERY POOR |
| EXAMPLE 1 | | |
| COMPARATIVE | RECTANGULAR OPENING | POOR |
| EXAMPLE 2 | (H0 < H2) | |
| COMPARATIVE | TRAPEZOIDAL NOTCH | POOR |
| EXAMPLE 3 | (H0 − H2) = 10 mm, H3 < H4 | |

As described above, the developing device according to exemplary aspects of the present invention include the corresponding partition wall having respective developer paths at both ends. These developer paths can reduce and/or prevent weak aggregation and blocking of the developer 34 that may occur at both ends of the developing device according to an increase of the number of print sheets. With the above-described structure, the image forming apparatus can provide printed images in high quality, without image noises, over a long period of time.

Further, the developing device according to exemplary aspects of the present invention include the layer thickness regulating member disposed in the vicinity of the bottom portion of the developing chamber. With the above-described structure, the developing device has no need to include a layer regulating member that is formed in a roller or that extends from an upper portion of the developing device toward the developer bearing member. Thereby, a low cost and/or low profile developing device can be obtained. As a result, the image forming apparatus can be a low profile and/or low cost image forming apparatus while reducing and/or preventing deterioration in durable images.

The above-described exemplary embodiments are illustrative, and numerous additional modifications and variations are possible in light of the above teachings. For example, elements and/or features of different illustrative and exemplary embodiments herein may be combined with each other and/or substituted for each other within the scope of this disclosure. It is therefore to be understood that the disclosure of this patent specification may be practiced otherwise than as specifically described herein.

What is claimed is:

1. A developing device, comprising:
a developer bearing member configured to bear a developer on a surface thereof;
a developer supplying member configured to supply the developer to the developer bearing member;
a regulating member configured to regulate the developer supplied on the surface of the developer bearing member to form into a thin layer, the regulating member located at a position lower than a nip of the developer bearing member and the developer supplying member; and
a partition wall configured to divide the developing device into two chambers, the partition wall arranged with at least one developer path having a bottom portion thereof located lower than a contact point of the developer bearing member and the regulating member.

2. The developing device according to claim 1, wherein:
the regulating member has one end in a longitudinal direction thereof being fixedly disposed on a bottom plate of one of the two chambers.

3. The developing device according to claim 1, wherein:
the bottom portion of the at least one developer path is formed outside of a width direction of an image forming area of the developing device.

4. The developing device according to claim 1, wherein:
the regulating member is configured to contact the developer bearing member and to have a free end extending in an upward direction over the contact point with the developer bearing member.

5. The developing device according to claim 4, wherein:
the at least one developer path in the image forming area is configured to be located upper than the free end.

6. The developing device according to claim 1, wherein:
the developing device is integrally mounted in a cartridge detachable with respect to an image forming apparatus.

7. A cartridge, comprising:
a housing; and
a developing device configured to develop an image, the developing device comprising:
a developer bearing member configured to bear a developer on a surface thereof;
a developer supplying member configured to supply the developer to the developer bearing member;
a regulating member configured to regulate the developer supplied on the surface of the developer bearing member to form into a thin layer, the regulating member located at a position lower than a nip of the developer bearing member and the developer supplying member; and
a partition wall configured to divide the developing device into two chambers, the partition wall arranged with at least one developer path having a bottom portion thereof located lower than a contact point of the developer bearing member and the regulating member.

8. The cartridge according to claim 7, wherein:
the regulating member has one end in a longitudinal direction thereof being fixedly disposed on a bottom plate of one of the two chambers.

9. The cartridge according to claim 7, wherein:
the bottom portion of the at least one developer path is formed outside of a width direction of an image forming area of the developing device.

10. The cartridge according to claim 7, wherein:
the regulating member is configured to contact the developer bearing member and to have a free end extending in an upward direction over the contact point with the developer bearing member.

11. The cartridge according to claim 10, wherein:
the at least one developer path in the image forming area is configured to be located upper than the free end.

12. An image forming apparatus, comprising:
an image bearing member configured to bear an image on a surface thereof;
a fixing device configured to fix the developer transferred from the image bearing member onto a recording medium; and
a developing device configured to develop the image formed on the surface of the image bearing member, the developing device comprising:
a developer bearing member configured to bear a developer on a surface thereof;
a developer supplying member configured to supply the developer to the developer bearing member;
a regulating member configured to regulate the developer supplied on the surface of the developer bearing member to form into a thin layer, the regulating member located at a position lower than a nip of the developer bearing member and the developer supplying member; and
a partition wall configured to divide the developing device into two chambers, the partition wall arranged with at least one developer path having a bottom portion thereof located lower than a contact point of the developer bearing member and the layer regulating member.

13. The image forming apparatus according to claim 12, wherein:
the regulating member has one end in a longitudinal direction thereof being fixedly disposed on a bottom plate of one of the two chambers.

14. The image forming apparatus according to claim 12, wherein:
the bottom portion of the at least one developer path is formed outside of a width direction of an image forming area of the developing device.

15. The image forming apparatus according to claim 12, wherein:
the regulating member is configured to contact the developer bearing member and to have a free end extending in an upward direction over the contact point with the developer bearing member.

16. The image forming apparatus according to claim 15, wherein:
the at least one developer path in the image forming area is configured to be located upper than the free end.

17. The image forming apparatus according to claim 12, wherein:
the developing device is integrally mounted in a cartridge detachable with respect to an image forming apparatus.

18. A method of manufacturing a developing device for conveying developer therein, comprising:
providing a developer bearing member and a regulating member in the developing device so that the regulating member is held in contact with the developer bearing member at a contact point; and
arranging a partition wall with at least one developer path having a bottom portion thereof located lower than the contact point of the developer bearing member and the layer regulating member.

19. The method according to claim 18, further comprising:
arranging the regulating member to have a free end extending in an upward direction over the contact point with the developer bearing member; and
locating the at least one developer path in the image forming area to be upper than the free end.

20. The method according to claim 18, wherein:
the developing device is integrally mounted in a cartridge detachable with respect to an image forming apparatus.
